(19) United States
(12) Patent Application Publication
(10) Pub. No.: US 2008/0284565 A1
(43) Pub. Date: Nov. 20, 2008

(54) Apparatus, System and Methods for Supporting an Authentication Process

(76) Inventor: Alexander Michael Duffy, New South Wales (AU)

Correspondence Address: BROOKS KUSHMAN P.C., 1000 TOWN CENTER, TWENTY-SECOND FLOOR, SOUTHFIELD, MI, 48075, US

(21) Appl. No.: 11/569,818

(22) PCT Filed: May 31, 2005
(86) PCT No.: PCT/AU2005/000771

§ 371 Date: Nov. 30, 2006

(30) Foreign Application Priority Data
May 31, 2004 (AU) 2004902904

(51) Int. Cl. G06K 9/00

(52) U.S. Cl. 340/5.86

(57) ABSTRACT

An apparatus for obtaining information that can be used to authenticate an entity, the apparatus comprising: an image capturing means arranged to capture an image; an image processor arranged to process the image in order to retrieve a block of ciphertext encoded in the image; and a data processor arranged to decrypt the block of ciphertext in order to obtain the information that can be used to authenticate the entity.

### FIELD OF THE INVENTION

The present invention relates generally to an apparatus and method for obtaining information that can be used to authenticate an entity, and a system and method for processing information that can be used to authenticate an entity. The present application has particular—but by no means exclusive—application to authentication over a public access computer network such as the Internet.

### BACKGROUND OF THE INVENTION

Authentication is a technique widely used to identify an entity. For example, many of today's computer systems employ authentication as a means for identifying users of the system. The most common authentication technique used today is based on a “username” and “password” that are generally unique to a particular entity. In existing computer systems, for example, the operating systems are typically arranged to prompt a user of the system for their username and password. By checking the computer system's internal records, the operating system is able to verify whether the user is who they claim to be.

Due to the widespread adoption of computer related technology (which generally rely on authentication) it is not uncommon for people to have many usernames and passwords, each being used to access different systems. For example, a person may have a username and password for their personal computer, a username and password for their on-line banking website, and a username and password for their Internet service provider. For security purposes people should ensure that each username and password they have is different to any other username and password they have. Furthermore they should ensure that at least each password they have is a ‘random’ sequence of alphanumeric characters. Unfortunately, this can make it difficult for people to readily recall their usernames and passwords. Consequently, people tend to choose passwords that are easy for them to recall; for instance, they may opt to use the name of their partner as their password. To make it even easier to recall passwords people will often use a common password instead of different passwords. The affect of this is that it can make it easy for an unauthorised party to guess passwords, and if the unauthorised party does correctly guess one password, they potentially have access to all of the person's systems due to the use of a common password

Furthermore, existing authentication processes based on a username and password can be susceptible to a man-in-the-middle attack. This susceptibility is particularly relevant where a username and password is exchanged via, for example, the Internet. By using the man-in-the-middle attack an unauthorised party can eavesdrop on communication between two computer systems in order to obtain the username and password of the person.

### SUMMARY OF THE INVENTION

According to a first aspect of the present invention there is provided an apparatus for obtaining information that can be used to authenticate an entity, the apparatus comprises:
an image capturing means arranged to capture an image;

an image processor arranged to process the image in order to retrieve a block of ciphertext encoded in the image; and

a data processor arranged to decrypt the block of ciphertext in order to obtain the information that can be used to authenticate the entity.

Thus, the apparatus has an advantage of being able to support an authentication process that does not require an entity to remember a password and which is not as susceptible to man-in-the-middle attacks as existing authentication processes. The fact that the password (the authentication information) is obtained from the image effectively avoids the need for the entity to remember the password because it is encoded in the image. Furthermore, use of a man-in-the-middle attack to gain unauthorised assess to the password is mitigated because the password encoded in the image is encrypted (the block of ciphertext).

Preferably, the image processor is further arranged to process the image in order to retrieve a digital signature encoded in the image, the data processor being arranged to process the digital signature in order to determine an authenticity of the block of ciphertext.

Thus, being able to determine the authenticity of the block of ciphertext is advantageous because it enables the apparatus to establish a level of trust in the block of ciphertext. Effectively, this enables the apparatus to assess whether the block of ciphertext has originated from a trusted source.

Preferably, the data processor is further arranged to decrypt the block of ciphertext in order to obtain a message for a user of the apparatus.

Thus, decrypting the block of ciphertext is advantageous because it can be used to convey additional information to the user.

Preferably, the apparatus further comprises a visual display, wherein the data processor is arranged to interact with the visual display in order to display the information and the message to the user.

Preferably, the image capturing means is arranged to capture the image from a computer screen.

Thus, being able to capture the image from a computer screen is advantageous because it enables the authentication process to be applied, for example, over the Internet. In this example, the image would typically be transferred over the Internet to a remote computer, which in turn would display the image on the computer screen.

Preferably, the apparatus is of a size that enables the apparatus to be readily carried in the hand of the user.

According to a second aspect of the present invention there is provided a system for processing information that can be used to authenticate an entity, the system comprising:

a data processor arranged to encrypt the information in order to create a block of ciphertext; and

an image processor arranged to encode an image with the block of ciphertext, thereby processing the information that can be used to authenticate the entity.

Thus, the system has an advantage of being able to support an authentication process that does not require an entity to remember a password and which is not as susceptible to man-in-the-middle attacks as existing authentication processes. The fact that the password (the authentication information) is effectively encoded in the image removes the need for the entity to remember the password because it is encoded in the image. Furthermore, use of a man-in-the-middle attack to gain unauthorised assess to the password is mitigated because the password is encrypted (the block of ciphertext).

Preferably, the data processor is further arranged to obtain a digital signature that can be used by an apparatus to determine an authenticity of the block of ciphertext, and the image processor is further arranged to encode the image with the digital signature.

Thus, enabling the apparatus to determine the authenticity of the block of ciphertext is advantageous because it enables the apparatus to establish a level of trust in the block of ciphertext. Effectively, this allows the apparatus to assess whether the block of ciphertext has originated from a trusted source.

Preferably, the data processor is further arranged to encrypt a message, for a user of the apparatus, in order to create the block of ciphertext.

Thus, this is advantageous because the message can be used to convey additional information to the user.

Preferably, the system further comprises an interface for receiving an identifier of the apparatus, the data processor being further arranged to process the identifier in order to obtain a digital key that can be used by the data processor to obtain the digital signature.

According to a third aspect of the present invention there is provided a method of obtaining information that can be used to authenticate an entity, the method comprising the steps of:

capturing an image;

processing the image in order to retrieve a block of ciphertext encoded in the image; and

decrypting the block of ciphertext in order to obtain the information that can be used to authenticate the entity.

Preferably, the step of processing the image further comprises the step of processing the image in order to retrieve a digital signature encoded in the image, and the method further comprises the step of processing the digital signature in order to determine an authenticity of the block of ciphertext.

Preferably, the step of decrypting the block of ciphertext further comprises the step of decrypting the block of ciphertext in order to obtain a message for a user of the apparatus.

Preferably, the method further comprises the step of interacting with the visual display in order to display the information and the message to the user.

Preferably, the step of capturing the image comprises the step of capturing the image from a computer screen.

According to a fourth aspect of the present invention there is provided a method of processing information that can be used to authenticate an entity, the method comprising the steps of:

encrypting the information in order to create a block of ciphertext; and

encoding an image with the block of ciphertext, thereby processing the information that can be used to authenticate the entity.

Preferably, the method further comprises the steps of:

obtaining a digital signature that can be used by an apparatus to determine an authenticity of the block of ciphertext; and

encoding the image with the digital signature.

Preferably, the method further comprises the step of encrypting a message, for a user of the apparatus, in order to create the block of ciphertext.

Preferably, the method further comprises the steps of:

receiving an identifier of the apparatus; and

processing the identifier in order to obtain a digital key that can be used to obtain the digital signature.

According to a fifth aspect of the present invention there is provided a computer program comprising at least one instruction for causing a computing device to carry out the method as described in the third or fourth aspect of the present invention.

According to a sixth aspect of the present invention there is provided a computer readable medium comprising the computer program according to the fifth aspect of the present invention.

### BRIEF DESCRIPTION OF THE DRAWINGS

Notwithstanding any other embodiments that may fall within the scope of the present invention, an embodiment of the present invention will now be described, by way of example only, with reference to the accompanying figures, in which:

FIG. 1 provides a block diagram of a computer system embodying the present invention;

FIG. 2 provides a flow chart of an authentication process used in the computer system illustrated in FIG. 1;

FIG. 3 is shows an image created by the computer system illustrated in FIG. 1;

FIG. 4 is a block diagram of an authentication apparatus used in the computer system illustrated in FIG. 1; and

FIG. 5 provides a flow chart of a method performed by the authentication apparatus of FIG. 4.

### AN EMBODIMENT OF THE INVENTION

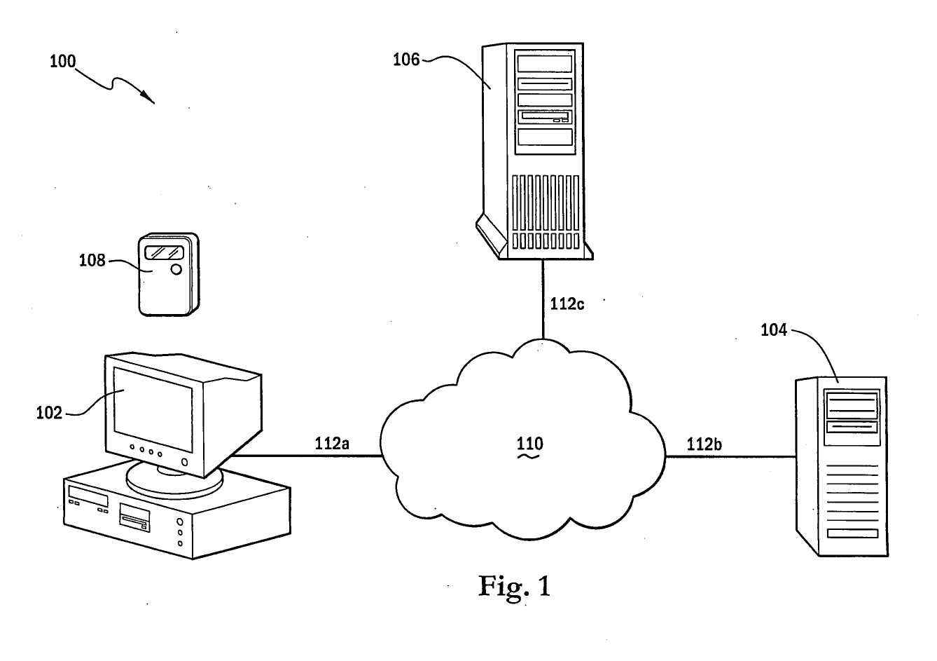

With reference to FIG. 1, which shows a system 100 embodying the present invention, the system 100 comprises a personal computer 102, a web server 104, a key server 106, an authentication apparatus 108, and a computer network 110 that is in the form of the Internet. The personal computer 102, web server 104 and key server 106 are connected to the computer network 110 via data links 112.

The web server 104 is in the form of a computer server and as such comprises traditional computer hardware such as a motherboard, power supply, random access memory and a hard disk. The web server 104 is loaded with an operating system (such as Linux or Microsoft Server 2003) for performing system level functions and for providing an environment in which application software can be executed. In addition to the operating system the web server 104 is loaded with a web server software package (such as Apache) that enables the web server 104 to function as a web server. In addition to the typical computer hardware, the web server 104 comprises a network interface card that enables the web server 104, or more specifically the web server software package, to receive and send data to the personal computer 102 and the key server 106.

To log-on to the web server 104, a person uses the personal computer 102. In this regard, the personal computer 102 comprises traditional computer hardware such as a motherboard, power supply, random access memory, a hard disk, keyboard and a monitor. In addition to the hardware, the personal computer 102 comprises an operating system (such as Microsoft Windows), which is loaded on the hard disk, for performing system level operations and providing an environment for running application software. The personal computer 102 also comprises a web browser application (such as Microsoft Internet Explorer). In addition to the traditional computer hardware the personal computer 102 also comprises network hardware (not shown in the figures) that enables the personal computer 102 to exchange data with the web server 104 via the computer network 110. The network hardware comprises a modem that enables the personal computer 102 to be connected to a network service provider, via the data link 112a, that provides the personal computer 102 with access to the computer network 110.

To logon to the web server 104, the person enters the web address of the web server 104 into the web browser (which is being executed by the personal computer 102). Using the web address the web browser will then attempt to contact the web server 104. The web browser is such that it attempts to establish contact with the web server 104 via the computer network 111 using the Hyper Text Transfer Protocol (HTTP).

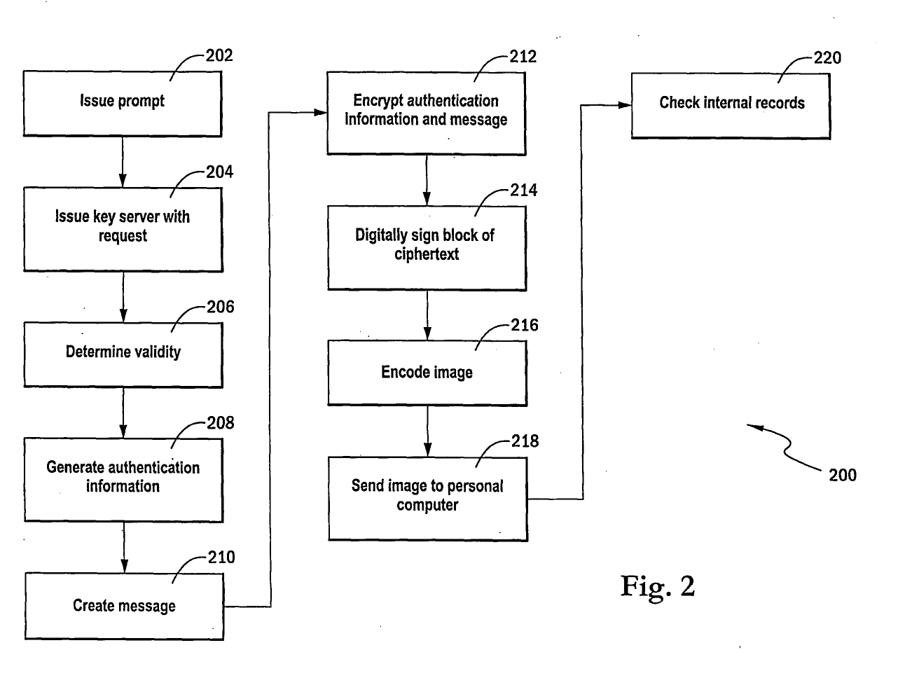

On receiving a HTTP connection request from the web browser, the web server 104 initiates an authentication process, the steps of which are illustrated in the flow chart 200 of FIG. 2. The web server 104 is loaded with software that performs the steps of the flow chart 200. The web server 104 essentially carries out the authentication process to verify that the person using the personal computer 102 is who they claim to be.

With reference to FIG. 2, the first step 202 that the web server 104 carries out is to issue a prompt to the person for an identifier of the authentication apparatus 108. The identifier is in the form of a series of numbers and/or letters. The prompt issued to the person is in the form of a web page that the web server 104 sends to the personal computer 102. On receiving the web page, the personal computer 103 displays the web page in the web browser to thereby present the prompt to the person. For the person to provide the identifier of the authentication device 108 the person simply enters the identifier into the web page being displayed by the web browser, subsequent to which the web browser sends the identifier to the web server 104 via the computer network 110.

On receiving the identifier from the web browser, the web server 104 carries out the step 204 of issuing the key server 106 with a request for a public encryption key. The request is in the form of a data packet that the web server 104 sends to the key server 106 via the computer network 110. The request that the web server 104 sends to the key server 106 comprises the identifier of the authentication apparatus 108 that the web server 104 previously received from the web browser running on the personal computer 102.

Subsequent to receiving the request, the key server 106 extracts the identifier from the request and retrieves from its local database a public encryption key that is associated with the extracted identifier. The retrieved public key is then digitally signed, using the RSA public key algorithm, and sent to the web server 104 via the computer network 111. The public encryption key is generated around the time the authentication apparatus 109 is initialised. The public encryption key is typically generated, using the RSA public key algorithm by a manufacturer of the authentication apparatus 108 and subsequently loaded into the key server 106.

In order to perform the previous steps, the key server 106 comprises traditional computer hardware such as a motherboard, a power supply, random access memory, and a hard disk. The hard disk of the key server is also loaded with operating system software (such as Microsoft Server 2003 or Linux). The operating system software performs various system level functions and provides an environment for executing application software. The key server 106 is also loaded with a software application that performs the tasks of extracting the identifier from the request and using the identifier to obtain the public encryption key. In addition to having traditional hardware the key server 107 also comprises network hardware/software that enables it to communicate with the web server 104 via the computer network 110. The network hardware/software is in the form of a network interface card.

Once the web server 104 has received the public encryption key from the key server 106, the first step 206 that it carries out is to determine the validity of the public encryption key by assessing the authenticity of the associated digital signature. In this regard, the web server 104 uses a hashing algorithm to assess the authenticity of the digital signature. Assuming the digital signature is deemed to be authentic, the web server 104 carries out the next step 208 of generating authentication information. The authentication information is effectively equivalent to a password used in a traditional username/password authentication scheme. The authentication information would typically comprise a string of alphanumeric characters. To generate the authentication information the web server 104 uses a pseudo-random generator, which is arranged such that the likelihood of generating the same authentication information twice is relative low. The web server 104 then proceeds with the step 210 of creating a message that is intended for the person; for instance, the message may confirm an action that the person wants the web server 104 to perform. As an example, if the web server 104 was being used to transfer money between bank accounts then the message may be “transfer $100 from account #1234 to account #5678”.

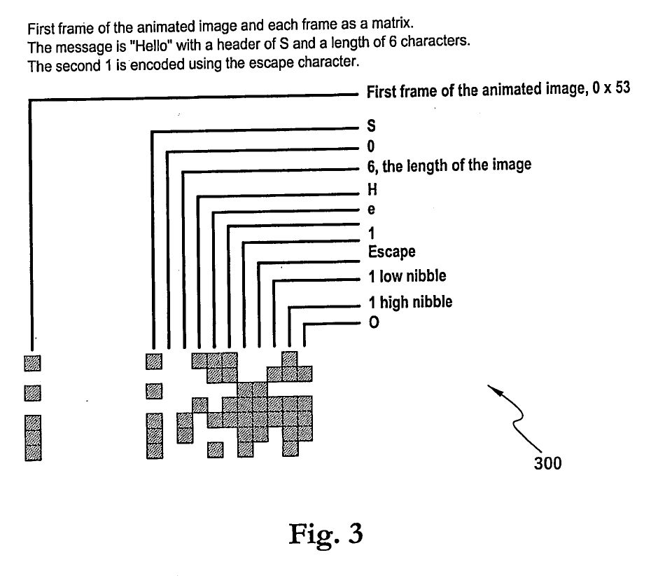

Subsequent to carrying out the previous step 210, the web server 104 performs the step 212 of using the public encryption key received from the key server 106 to encrypt the authentication information and the message, to thereby create a block of ciphertext. In this regard, the web server 104 uses the RSA public key encryption algorithm. The web server 104 then proceeds to carry out the step 214 of digitally signing the block of ciphertext using the RSA algorithm. Subsequent to the previous step 214 the web server 104 performs the step 216 of encoding the digitally signed block of ciphertext into an image 300. The image 300, which is illustrated in FIG. 3, is in the form of an animated data matrix. The animated characteristic of the image 300 enables more data to be encoded than a corresponding static image. It is, however, envisaged that a static image could be used in an alternative embodiment of the present invention. It will be appreciated that whilst the embodiment of the present invention uses an image in the form of a data matrix, it is possible to use an image in the form of a bar code, aztec code or ultra code in alternative embodiments of the present invention.

Once the web server 104 has carried out the previous step 216, the web server 104 performs the step 218 of sending the image 300 to the personal computer 102 via the computer network 110. The web server 104 sends the image 300 to the personal computer 102 by encapsulating the data representing the image 300 in to one or more packets, which are transferred by the computer network 110. On receiving the image 300 the personal computer 102 displays the image 300 in the web browser running on the personal computer 102.

In order to enable the web server 104 to authenticate the person, the person holds the authentication apparatus 108 to the screen of the personal computer 102 such that the authentication apparatus 108 can capture the image 300. As mentioned previously, the image 300 is displayed in the web browser, which enables the authentication apparatus 108 to capture the image 300 from the screen.

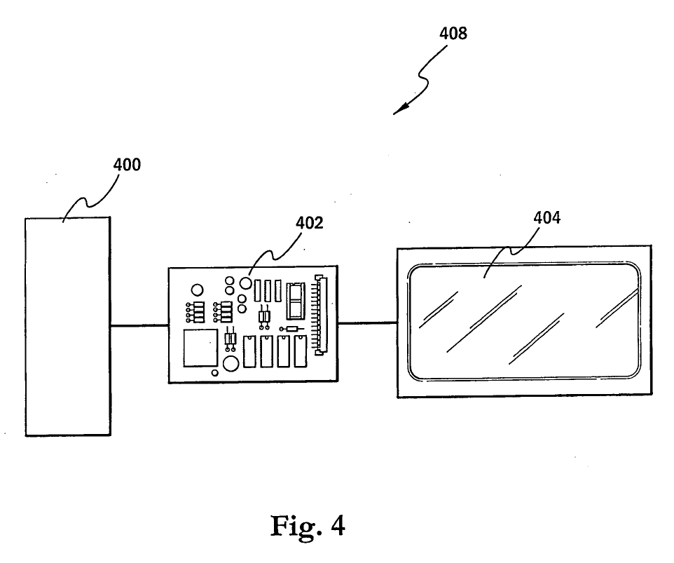

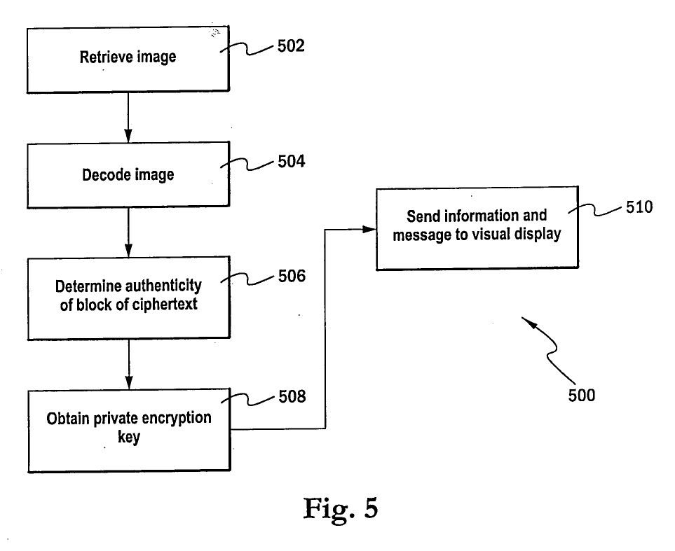

With reference to FIG. 4, which provides a block diagram of the authentication apparatus 108, the authentication apparatus 108 comprises a strip sensor 400 for capturing the image 300, a processor 402 that it electrically coupled to the strip sensor 400, and a visual display 404 that is electrically coupled to the processor 402. It will be appreciated that in other embodiments of the present invention the strip sensor 400 may be replaced with another form of sensor such as a matrix sensor. In order to capture the image 300 from the monitor of the personal computer 102 the person holds the authentication apparatus 108 such that the strip sensor 400 is closely facing the image 300. The processor 402 is arranged to perform the various steps shown in the flow chart 500 of FIG. 5. The processor 402 is in the form of an integrated circuit that is programmed to carry out the steps shown in flow chart 500.

The first step 502 that the processor 402 carries out is to retrieve the image 300 captured by the strip sensor 400. Subsequent to the first step 502, the processor 402 then performs the step 504 of decoding the image 300 so as to retrieve the digitally signed block of ciphertext. The processor 402 then proceeds to determine the authenticity of the block of ciphertext by carrying out step 506, which involves the processor 402 checking the digital signature using a hashing algorithm. Assuming the digital signature is determined to be authentic, the processor 402 proceeds to carry out the step 508 of using a private encryption key to decrypt the block of ciphertext to obtain the authentication information and message created by the web server 104. In this regard, the processor 402 uses the RSA public key encryption algorithm to decrypt the block of ciphertext. Once the processor 402 has decrypted the block of ciphertext, the processor 402 proceeds to carry out the final step 510 of sending the authentication information and the message to the visual display 404 for presentation to the person.

By using the authentication information displayed on the visual display device 404 of the authentication apparatus 108, the person can allow the web server 104 to authenticate the person. In order to do this the person enters the authentication information (displayed on the visual display 404) into the web browser, which in turn sends the authentication information to the web server 104. In this regard, the authentication information is sent via the computer network 110 in at least one data packet. On receiving the authentication information from the web browser, the web server 104 carries out the step 220 of checking its internal records (which are maintained in a database) to determine whether the authentication information received from the web browser corresponds to the authentication information it created during the earlier step 208.

It will be appreciated that whilst the present embodiment of the invention is in the context of a personal computer interacting with a web server, the invention has application to other embodiments. For example, a personal digital assistant or mobile phone could be used instead of the personal computer 103.

Those skilled in the art will appreciate that the invention described herein is susceptible to variations and modifications other than those specifically described. It should be understood that the invention includes all such variations and modifications which fall within the spirit and scope of the invention.

1. An apparatus for obtaining information that can be used to authenticate an entity, the apparatus comprising:
an image capturing means arranged to capture an image;
an image processor arranged to process the image in order to retrieve a block of ciphertext and a digital signature that are encoded in the image; and
a data processor arranged to decrypt the block of ciphertext in order to obtain the information that can be used to authenticate the entity, and to process the digital signature in order to determine an authenticity of the block of ciphertext.

2. The apparatus as claimed in claim 1, wherein the data processor is further arranged to decrypt the block of ciphertext in order to obtain a message for a user of the apparatus.

3. The apparatus as claimed in claim 2, further comprises a visual display, and wherein the data processor is arranged to interact with the visual display in order to display the information and the message to the user.

4. The apparatus as claimed in claim 1, wherein the image capturing means is arranged to capture the image from a computer screen.

5. A system for processing information that can be used to authenticate an entity, the system comprising:
a data processor arranged to encrypt the information in order to create a block of ciphertext, and to obtain a digital signature that can be used by an apparatus to determine an authenticity of the block of ciphertext; and
an image processor arranged to encode an image with the block of ciphertext and the digital signature, thereby processing the information that can be used to authenticate the entity.

6. The system as claimed in claim 5, wherein the data processor is further arranged to encrypt a message, for a user of the apparatus, in order to create the block of ciphertext.

7. The system as claimed in claim 5, further comprising an interface for receiving an identifier of the apparatus, wherein the data processor is further arranged to process the identifier in order to obtain a digital key that can be used by the data processor to obtain the digital signature.

8. A method of obtaining information that can be used to authenticate an entity, the method comprising the steps of:
capturing an image;
processing the image in order to retrieve a block of ciphertext and a digital signature that are encoded in the image;
decrypting the block of ciphertext in order to obtain the information that can be used to authenticate the entity; and
processing the digital signature in order to determine an authenticity of the block of ciphertext.

9. The method as claimed in claim 8, wherein the step of decrypting the block of ciphertext further comprises the step of decrypting the block of ciphertext in order to obtain a message for a user of the apparatus.

10. The method as claimed in claim 8, further comprising the step of interacting with a visual display in order to display the information and the message to the user.

11. The method as claim in claim 8, wherein the step of capturing the image comprises the step of capturing the image from a computer screen.

12. A method for processing information that can be used to authenticate an entity, the method comprising the steps of:
encrypting the information in order to create a block of ciphertext;
obtaining a digital signature that can be used by an apparatus to determine an authenticity of the block of ciphertext; and
encoding an image with the block of ciphertext and the digital signature, thereby processing the information that can be used to authenticate the entity.

13. The method as claimed in claim 12, further comprising the step of encrypting a message, for a user of the apparatus, in order to create the block of ciphertext.

14. The method as claimed in claim 12 further comprising the steps of:
receiving an identifier of the apparatus; and
processing the identifier in order to obtain a digital key that can be used to obtain the digital signature.

15. A computer program comprising at least one instruction for causing a computing device to carry out the method as claimed in claim 8.

16. A computer readable medium comprising the computer program as claimed in claim 15.

17.-19. (canceled)

20. The apparatus as claimed in claim 2, wherein the image capturing means is arranged to capture the image from a computer screen.

21. The apparatus as claimed in claim 3, wherein the image capturing means is arranged to capture the image from a computer screen.

22. The system as claimed in claim 6, further comprising an interface for receiving an identifier of the apparatus, wherein the data processor is further arranged to process the identifier in order to obtain a digital key that can be used by the data processor to obtain the digital signature.

23. The method as claimed in claim 9, further comprising the step of interacting with a visual display in order to display the information and the message to the user.
